(19) United States
(12) Patent Application Publication
(10) Pub. No.: US 2007/0091215 A1
(43) Pub. Date: Apr. 26, 2007

(54) Fold-down monitoring apparatus

(76) Inventor: Takahiro Ikunami, Tokyo (JP)

Correspondence Address: BIRCH STEWART KOLASCH & BIRCH, PO BOX 747, FALLS CHURCH, VA, 22040-0747, US

(21) Appl. No.: 10/579,833

(22) PCT Filed: Jul. 4, 2005
(86) PCT No.: PCT/JP05/12337

§ 371 Date: May 17, 2006

(30) Foreign Application Priority Data
Oct. 6, 2004 (JP) 2004-293998

(51) Int. Cl. H04N 5/64

(52) U.S. Cl. 348/837

(57) ABSTRACT

A display holding member 3 includes an insertion hole 3c which is made to face toward a vehicle's ceiling 1 when the display holding member 3 is placed in an accommodated position, the insertion hole 3c being formed in the vicinity of a housing 2 and an axis of rotation 6, and an FPC cover 4 which is pressed by a spring 4b so as to be pivotably disposed. When the display holding member 3 is placed in the accommodated position, the appearance of the display holding member 3 in which the insertion hole 3c is formed covers the FPC 7 so that the FPC 7 cannot be visually identified from outside, and the FPC cover 4 also covers the FPC 7 while the display holding member 3 pivots from the folded position to a visually-identified position.

### FIELD OF THE INVENTION

The present invention relates to a fold-down monitoring apparatus in which a connecting member, such as an FPC (Flexible Printed Circuit), for electrically connecting a main body of the monitoring apparatus to a display unit which can be pivotably disposed in the fold-down monitoring apparatus is covered so that it cannot be visually identified from outside, thereby improving the design quality of the fold-down monitoring apparatus.

### BACKGROUND OF THE INVENTION

There has been provided the following related art fold-down monitoring apparatus which is mounted on the roof of a vehicle or the like, which is placed in a folded state in which a display unit is accommodated in a main body when it is not in use, and which places the display unit in an unfolded state when it is in use, for displaying an image on the display unit.

This fold-down monitoring apparatus has a television mounting opening formed in a ceiling trim of the ceiling (roof) of the cabin, and a TV including a base plate, a TV main body which is attached to this base plate so as to freely move upward or downward and to pivot, and a frame-shaped cover member for enclosing the outer surface of the TV main body. The back and front edges of the base plate are placed on the upper surfaces of the back and front opening edges of the above-mentioned television mounting opening, respectively, so that the opening can be stopped up. The back and front peripheral edges of the cover member is brought into contact with the lower surfaces of the back and front opening edges of the opening, respectively, a stopping part disposed in the cover member is secured to the base plate, and the back and front opening edges of the opening is sandwiched between the front edge of the base plate and the front peripheral edge of the cover member and is also sandwiched between the back edge of the base plate and the back peripheral edge of the cover member. As a result, the related art fold-down monitoring apparatus is simplified in structure, and implements a mounting mechanism for mounting the TV for vehicles without any gap in a portion in which the TV is mounted on the cabin's ceiling (for example, refer to patent reference 1).

Patent reference 1: JP,2001-105988,A

A problem with the related art fold-down monitoring apparatus constructed as mentioned above is that since it does not have a mechanism for covering (or hiding) a connecting member, such as an FPC, for electrically connecting the TV to the main body mounted to a vehicle cabin's ceiling so that the connecting member cannot be visually identified from outside, this connecting member, such as an FPC, is visually identified from outside with being in the state in which the display unit is accommodated in the main body or is unfolded, and therefore the design quality of the related art fold-down monitoring apparatus is reduced.

As measures against this problem, there can be provided a method of painting the connecting member, such as an FPC, according to the colors of the surrounding designed components. A problem with this method is, however, that when one of two or more colors can be selected for this painting, consistency cannot be provided among the components and this results in increase in the manufacturing cost.

A further problem is that the connecting member, such as an FPC, can be prevented from being bent due to hardening caused by the painting when the display unit is unfolded or folded, and therefore an unusual sound can occur.

The present invention is made in order to solve the above-mentioned problems, and it is therefore an object of the present invention to provide a fold-down monitoring apparatus which covers a connecting member, such as an FPC, for electrically connecting a main body disposed in a housing to a display unit pivotably disposed in the fold-down monitoring apparatus so that the connecting member cannot be visually identified from outside regardless of an angle by which the display unit is made to pivot, thereby improving the design quality of the fold-down monitoring apparatus.

### DISCLOSURE OF THE INVENTION

A fold-down monitoring apparatus in accordance with the present invention includes a display holding member which is pivotably supported by a housing mounted to a vehicle's roof via an axis of rotation so as to pivot from an accommodated position to a visually-identified position, a connecting member for electrically connecting a main body disposed in the above-mentioned housing to a display, an insertion hole which is located in a vicinity of the above-mentioned axis of rotation and which is disposed in the above-mentioned display holding member so that the above-mentioned connecting member is inserted thereinto and is covered to prevent the above-mentioned connecting member from being visually identified from outside, and a connecting member covering member which is attached to a part of the housing in a vicinity of the above-mentioned axis of rotation so as to be pressed and to pivot as the above-mentioned display holding member pivots, for covering the above-mentioned connecting member so that the above-mentioned connecting member cannot be visually identified from outside.

In accordance with the present invention, the insertion hole is disposed in the above-mentioned display holding member so as to be located in the vicinity of the axis of rotation, and the connecting member covering member is attached to a part of the housing in the vicinity of the above-mentioned axis of rotation so as to be pressed and to pivot as the display holding member pivots, and, when the display holding member is placed in the accommodated position, the appearance of the display holding member in which the above-mentioned insertion hole is formed covers the connecting member so that the connecting member cannot be visually identified from outside, and the above-mentioned connecting member covering member also covers the connecting member while the display holding member pivots from the folded position to the visually-identified position. Therefore, even if the display holding member pivots from the folded position to the visually-identified position, the connecting member can be prevented from being visually identified in the meantime regardless of an angle by which the display holding member is made to pivot.

Furthermore, since the pressing force acts on the connecting member covering member, the connecting member covering member is prevented from causing an oscillating unusual sound due to vibrations or the likes which occur when the vehicle is traveling.

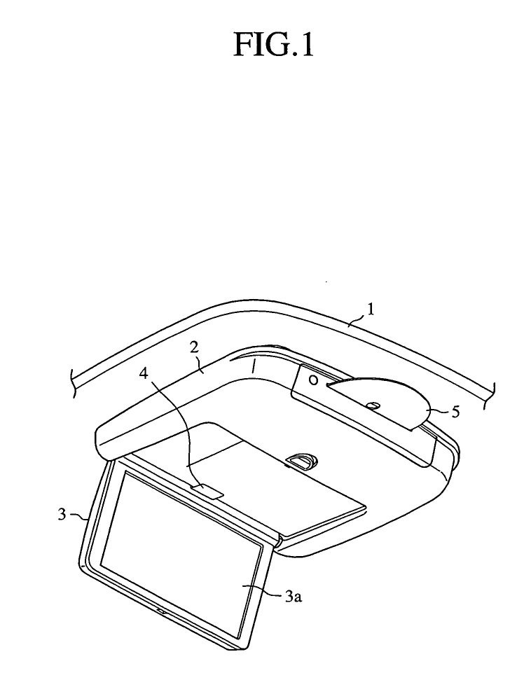

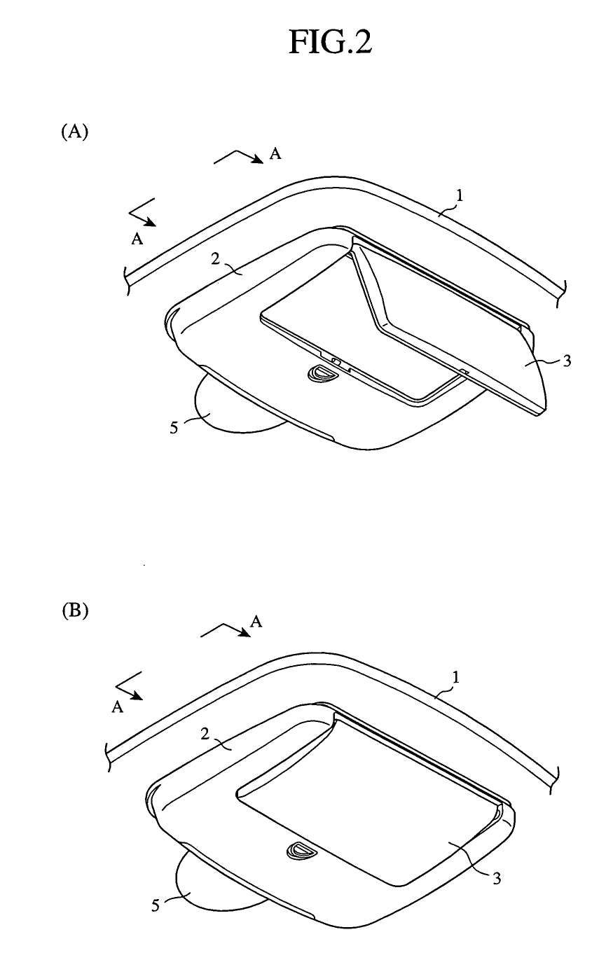

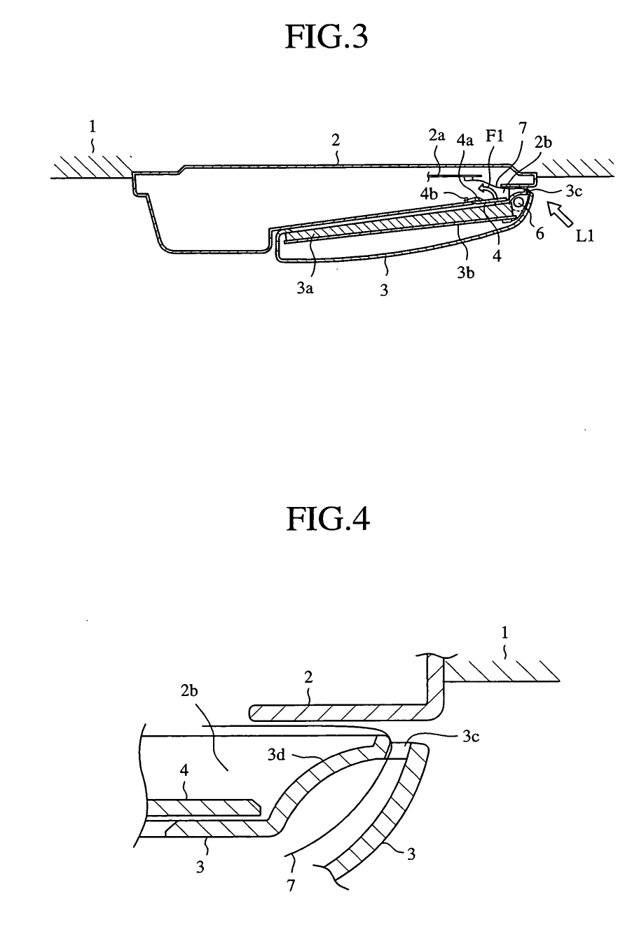

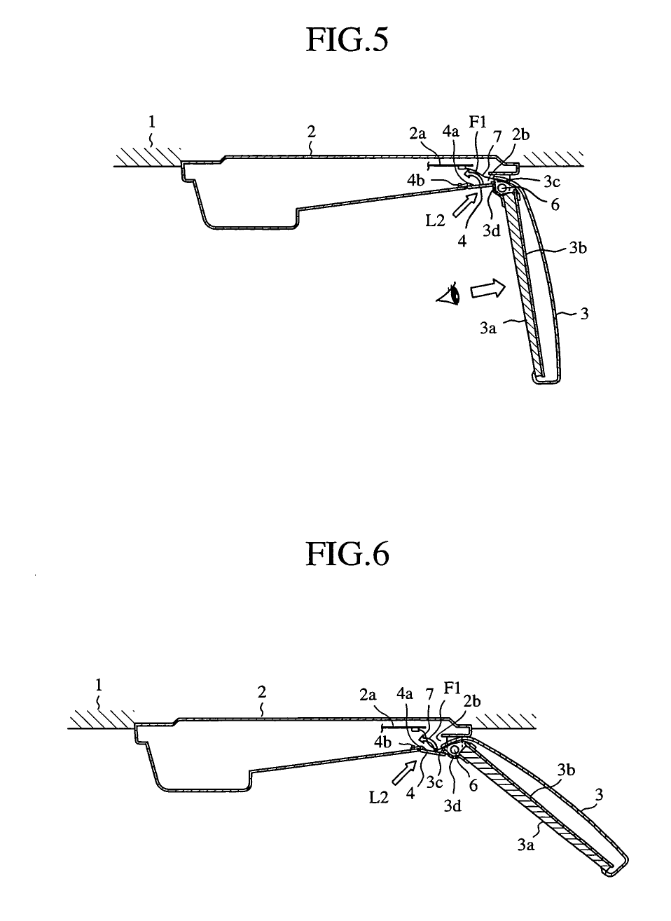

### BRIEF DESCRIPTION OF THE FIGURES

[FIG. 1] FIG. 1 is a perspective view showing the outward appearance of a fold-down monitoring apparatus in accordance with embodiment 1 of the present invention when viewed from a display screen thereof;

[FIG. 2A] FIG. 2A is a figure showing the outward appearance of the fold-down monitoring apparatus in accordance with embodiment 1 of the present invention when viewed from a display rear surface thereof, and is a perspective view showing a state in which a display holding member is made to pivot and is then placed in a visually-identified position;

[FIG. 2B] FIG. 2B is a figure showing the outward appearance of the fold-down monitoring apparatus in accordance with embodiment 1 of the present invention when viewed from the display rear surface thereof, and is a perspective view showing a state in which the display holding member is accommodated in a housing;

[FIG. 3] FIG. 3 is a perspective side view showing the state in which the display holding member is accommodated in the housing when viewed along the direction of the line A-A of FIG. 2B;

[FIG. 4] FIG. 4 is a partly enlarged view showing an insertion hole formed in the display holding member shown in FIG. 3, and parts disposed in the housing and in the vicinity of the insertion hole;

[FIG. 5] FIG. 5 is a perspective side view showing the fold-down monitoring apparatus in which the display holding member is placed in the visually-identified position when viewed along the direction of the line A-A of FIG. 2A; and

[FIG. 6] FIG. 6 is a perspective side view showing the fold-down monitoring apparatus in which the display holding member shown in FIG. 5 is placed in the visually-identified position with a maximum unfolded angle.

### PREFERRED EMBODIMENTS OF THE INVENTION

Hereafter, in order to explain this invention in greater detail, the preferred embodiments of the present invention will be described with reference to the accompanying drawings.

### Embodiment 1

FIG. 1 is a perspective view showing the outward appearance of a fold-down monitoring apparatus in accordance with embodiment 1 of the present invention, and shows a display screen when viewed from seats of a vehicle in which the fold-down monitoring apparatus is mounted.

As shown in FIG. 1, a housing 2 of this fold-down monitoring apparatus is mounted on a roof 1 of the vehicle, and a display holding member 3 which can pivot from a folded position in which it is accommodated in the housing, via an unfolding position in which it is being unfolded, to a visually-identified position in which it can be visually identified from outside is disposed in the fold-down monitoring apparatus. This housing 2 serves as the cabinet of this fold-down monitoring apparatus that accommodates the display holding member 3 therein.

FIG. 1 is a perspective view showing a state in which the display holding member 3 is placed in the visually-identified position, and this display holding member 3 is provided with a display 3a consisting of a liquid crystal display (LCD) or the like, for displaying an image.

An FPC cover 4 (i.e., a connecting member covering member) for keeping a connecting member (referred to as “FPC” from here on), such as an FPC, out of view so that the connecting member cannot be visually identified from outside is disposed in the housing 2, and an insertion opening via which a disk 5, such as a DVD (Digital Versatile Disc), is inserted into the fold-down monitoring apparatus is formed in the housing 2. The outward appearance of the fold-down monitoring apparatus shown in above-mentioned FIG. 1 when viewed from a side of a rear surface of the display is shown in FIG. 2.

FIG. 2 is a perspective view showing the outward appearance of the fold-down monitoring apparatus in accordance with embodiment 1 of the present invention, and shows the rear surface of the display when viewed from a driver s seat. FIG. 2A is a perspective view showing a state in which the display holding member 3 is made to pivot and is then placed in the visually-identified position, and FIG. 2B is a perspective view showing a state in which the display holding member is accommodated in the housing 2. The same reference numerals of FIGS. 2A and B as shown in FIG. 1 denote the same components, respectively.

As shown in FIGS. 2A and 2B, the display holding member 3 is so constructed as to be made to pivot from the position (folded position) in which it is accommodated in the housing 2 to the visually-identified position by way of the unfolding position.

Next, the concealment of the FPC will be explained with reference to FIGS. 3 to 6.

Each of FIGS. 3, 5, and 6 is a perspective side view of the fold-down monitoring apparatus when viewed along the direction of the line A-A of FIG. 2A or 2B (except for the disk 5), FIG. 3 is a view showing the folded position of the display holding member 3, FIG. 5 is a view showing the visually-identified position of the display holding member 3, and FIG. 6 is a view showing the visually-identified position of the display holding member 3 with a maximum unfolded angle. In these figures, the same components as shown in FIG. 1 are designated by the same reference numerals. The explanation of FIG. 4 will be done after the explanation of FIG. 3.

In FIG. 3, the display holding member 3 is supported so as to pivot freely around the axis of rotation 6, and is placed in the accommodated position where it is accommodated in the housing 2 mounted to the vehicle's roof 1 when it is not in use as shown in the figure. While this display holding member 3 is equipped with the display 3a for displaying a play-backed image or the like read from a disk 5 on a screen thereof, and a printed circuit board 3b which forms a driving circuit for driving this display 3a, the display holding member 3 has an insertion hole 3c which is made to face toward the vehicle's roof 1 when the display holding member 3 is placed in the accommodated position, and which covers and makes the FPC 7 be inserted thereinto so that this FPC 7 cannot be visually identified from outside, the insertion hole 3c being formed in the vicinity of the housing 2 and the axis of rotation 6. The display holding member 3 is substantially shaped like L having a corner around the axis of rotation 6, and the insertion hole 3c is formed in one end of the substantially-L-shaped display holding member. The FPC 7 is inserted into this insertion hole 3c, and the above-mentioned printed circuit board 3b is electrically connected to a printed circuit board 2a which constitutes the main body accommodated in the housing 2. The display screen of the display 3a faces the interior of the housing 2 when the display holding member is accommodated in the housing.

The axis of rotation 6 is placed so as to be close to the vehicle's roof 1 (i.e., the upper side of the monitoring apparatus) as much as possible. Thereby, when the display holding member 3 is unfolded toward the visually-identified position (which will be mentioned with reference to FIG. 5), interference in the field of view of the driver's seat side room mirror by this display holding member 3 can be reduced.

The above-mentioned printed circuit board 2a is accommodated in the housing 2, and an insertion hole 2b into which the FPC 7 for connecting this printed circuit board 2a to the printed circuit board for driving the display is inserted is formed in the housing 2.

In addition, the FPC cover 4 which forms the connecting member covering member attached to a part of the housing 2 in the vicinity of the axis of rotation 6 is pivotably disposed around an axis of rotation 4a, and is pressed toward the housing 2 (i.e., a direction of an arrow F1 shown in the figure) by an elastic member which consists of a spring 4b, for example. When the display holding member 3 is placed in the accommodated position, the FPC cover 4 is fixed to the housing 2 because of a pressing force by the spring 4b. The action of this pressing force prevents the FPC cover 4 from causing an oscillating unusual sound due to vibrations or the likes which occur when the vehicle is traveling.

Hereafter, a state in which the FPC 7 is inserted into the insertion hole 3c formed in the above-mentioned display holding member 3 and the insertion hole 2b formed in the housing 2 will be explained with reference to FIG. 4.

FIG. 4 is a partly enlarged view showing the insertion hole 3c formed in the display holding member 3 shown in FIG. 3, and components disposed in the housing 2 and in the vicinity of the insertion hole 2b.

The FPC 7 is inserted into the insertion hole 3c formed in the display holding member 3 and in the vicinity of the housing 2, and the insertion hole 2b formed in the housing 2, as shown in FIG. 4, and electrically connects the printed circuit board 2 an accommodated in the housing 2 to the printed circuit board 3b for driving the display 3a. A hook rotary member 3d is disposed in the display holding member 3 in which the insertion hole 3c is formed, and will be mentioned below in detail.

As can be seen from above-mentioned FIG. 3, when the display holding member 3 is placed in the accommodated position, although the FPC 7 can be identified most visually from a direction shown by an arrow L1 of the figure, since the insertion hole 3c formed in the display holding member 3, which is substantially shaped like L as mentioned above, is made to orient upward (i.e., face toward the vehicle's roof 1) and is close to the housing 2, the FPC 7 is covered by the appearance of the display holding member 3 so that it cannot be visually identified from outside even when viewed from the direction of the arrow L1 shown in the figure.

When the display holding member 3 is made to pivot from the above-mentioned accommodated position, by way of the unfolding position, to the display visually-identified position shown in FIG. 5, the FPC 7 is being covered so that it cannot be visually identified from the direction of the arrow L2 shown in the figure because of the FPC cover 4 even when it is placed in the unfolding position extending to the display visually-identified position. When this FPC cover 4 is not disposed, it is clear that the FPC 7 can be visually identified from the direction of the arrow L2 shown in the figure.

In the display visually-identified position shown in FIG. 5, the hook rotary member 3d of the display holding member 3 is brought into contact with the FPC cover 4.

In this case, the FPC cover 4 is so constructed as to be brought into contact with only the hook rotary member 3d. As a result, a problem of scratching the designed surface of the display holding member 3, and reducing the commercial value of the fold-down monitoring apparatus can be prevented from arising. However, any parts other than the hook rotary member 3d are not prevented from coming into contact with the FPC cover 4 as long as the designed surface of the display holding member 3 can be prevented from being scratched by using another method.

Also in the display visually-identified position shown in this FIG. 5, since the pressing force by the spring 4b acts on the FPC cover 4 as previously explained with reference to FIG. 3, the FPC cover 4 is prevented from causing an oscillating unusual sound due to vibrations or the likes which occur when the vehicle is traveling.

When the display holding member 3 is further made to pivot from the above-mentioned position shown in FIG. 5, and then moves to a maximum display unfolded angle position as shown in FIG. 6, the FPC cover 4 is kept in contact with the hook rotary member 3d of the display holding member 3 in a state in which the FPC cover 4 is pushed down in a clockwise direction opposite to a direction F1 toward which it is pressed, thereby preventing the FPC 7 from being visually identified from the direction of the arrow L2 shown in the figure. Thus, when the display holding member 3 is placed in the maximum display unfolded angle position shown in FIG. 6 or in the vicinity of this position, it can be made to pivot while pushing down the FPC cover 4 with the hook rotary member 3d.

As mentioned above, the FPC cover 4 can be made to pivot around the axis of rotation 4a by the above-mentioned pushing-down force of the hook rotary member 3d in the clockwise direction opposite to the direction F1 toward which it is pressed by the spring 4b. Thus, since the FPC cover 4 is brought into contact with the hook rotary member 3d while pivoting in the clockwise direction opposite to the direction F1 toward which it is pressed, the contact between the FPC cover and the hook rotary member is securely maintained because of the action of the pressing force of the spring 4b. As a result, the FPC cover 4 is prevented from causing an oscillating unusual sound, as in the case of FIG. 3 or 5.

In general, a stopper (not shown) is disposed so that the display holding member 3 does not pivot by a predetermined angle or more in the maximum display unfolded angle position shown in FIG. 6, and a margin is provided to the contact relationship between the FPC cover 4 and the hook rotary member 3d. Therefore, even if the display holding member 3 is placed in the position shown in FIG. 6, the contact between the FPC cover 4 and the hook rotary member 3d is not released. As a result, the FPC 7 can be always prevented from being visually identified from the direction of the arrow L2 shown in the figure.

In addition, when forming the hook rotary member 3d disposed in the insertion hole 3c of the display holding member 3, the insertion hole 3c can be formed by cutting and raising a part of the display holding member 3, and the cut and raised part can be used as the hook rotary member 3d of the FPC cover 4.

In this case, there is no necessity to form the hook rotary member 3d independently.

In the above explanation, although the connecting member for electrically connecting the main body in the housing 2 to the display holding member 3 is explained by taking the FPC 7 as an example, the connecting member is not limited to this FPC7. Needless to say, a flexible connecting member, such as a flat wire, can be used as the connecting member.

As mentioned above, the fold-down monitoring apparatus in accordance with this embodiment 1 includes the insertion hole 3c disposed in the display holding member 3 and in the vicinity of the axis of rotation 6, and the FPC cover 4 which is attached to the housing and in the vicinity of the above-mentioned axis of rotation 6 with being pressed by the spring 4b, and which pivots as the display holding member 3 pivots, and the display holding member 3 covers the FPC 7 in the accommodated position so that the FPC 7 cannot be visually identified from outside by the appearance of the display holding member 3 in which the insertion hole 3c is formed and the FPC cover 4 covers the FPC 7 so that the FPC 7 cannot be visually identified from outside while the display holding member 3 is made to pivot from the accommodated position to the visually-identified position. As a result, even if the display holding member 3 is made to pivot from the accommodated position to the visually-identified position by way of the unfolding position, the FPC 7 can be prevented from being visually identified from outside in the meantime regardless of an angle by which the display holding member 3 is made to pivot.

Furthermore, since the pressing force by the spring 4b acts on the FPC cover 4, the FPC cover 4 is prevented from causing an oscillating unusual sound (i.e., chatter) due to vibrations or the likes which occur when the vehicle is traveling, and vibration proof can be secured.

In addition, when the insertion hole 3c is formed by cutting and raising a part of the display holding member 3, and the cut and raised part is used as the hook rotary member 3d of the FPC cover 4, there is no necessity to form the hook rotary member 3d independently.

Furthermore, since the display holding member 3 having the above-mentioned insertion hole 3c, and the FPC cover 4 are disposed, there is no necessity to take measures to improve the so-called appearance of the fold-down monitoring apparatus, such as measures to paint the FPC 7 according to the colors of the surrounding designed components, and this results in no extra cost of painting. When one of two or more colors can be selected for this painting, consistency cannot be provided among the components and this results in increase in the manufacturing cost. However, in accordance with this embodiment, such a cost increase can be avoided.

In addition, since there is no necessity to take measures to paint the FPC 7, the FPC 7 cannot be prevented from being bent due to hardening caused by the painting when the display holding member 3 is unfolded or folded, and therefore any unusual sound can be prevented from occurring. As a result, the FPC 7 can carry out a bending operation by taking advantage of its original flexibility, and can make it possible for the display holding member 3 to be smoothly unfolded or folded. Furthermore, the problem of stripping off the paint can be prevented from arising.

Since the FPC cover 4 is opened without being in contact with the designed surface of the display holding member 3, but with being in contact with only the hook rotary member 3d, the problem of scratching the designed surface of the display holding member 3, and reducing the commercial value of the fold-down monitoring apparatus can be prevented from arising.

### INDUSTRIAL APPLICABILITY

As mentioned above, the fold-down monitoring apparatus in accordance with the present invention is suitable for preventing an electrical connecting member for electrically connecting a main body thereof to a display unit from being visually identified from outside, and for improving the design quality thereof.

1. A fold-down monitoring apparatus comprising:
a housing mounted to a ceiling of a vehicle, for accommodating a main body therein;
a display holding member which is pivotably supported by said housing via an axis of rotation so as to pivot from an accommodated position, by way of an unfolding position, to a visually-identified position;
a connecting member for electrically connecting the main body disposed in said housing to a display;
an insertion hole which is located in a vicinity of said axis of rotation and which is disposed in said display holding member so that said connecting member is inserted thereinto and is covered to prevent said connecting member from being visually identified from outside, and
a connecting member covering member which is attached to a part of said housing in a vicinity of said axis of rotation so as to be pressed toward a direction and to pivot as said display holding member pivots, for covering said connecting member so that said connecting member cannot be visually identified from outside.

2. The fold-down monitoring apparatus according to claim 1, characterized in that the insertion hole is formed by cutting and raising a part of the display holding member, and the cut and raised part is formed as a hook rotary member of the connecting member covering member.
